(19) United States
(12) Patent Application Publication
(10) Pub. No.: US 2014/0307496 A1
(43) Pub. Date: Oct. 16, 2014

(54) MULTI-OUTPUT POWER SOURCE WITH FOOLPROOF SEAL DEVICE

(71) Applicant: Kerio Technologies, Inc, Taipei (TW)

(72) Inventor: Jung-Chi Su, Taipei (TW)

(73) Assignee: Kerio Technologies, Inc, Taipei (TW)

(21) Appl. No.: 14/010,526

(22) Filed: Aug. 27, 2013

(30) Foreign Application Priority Data
Apr. 16, 2013 (CN) 201310131571.4

(51) Int. Cl. H02M 7/00

(52) U.S. Cl. CPC H02M 7/003
USPC 363/100

(57) ABSTRACT

The present invention relates to a multi-output power source provided with a foolproof seal device. The invention includes a housing formed with a plurality of exposed connection openings; an voltage-converting circuit having an output terminal; a plurality of output ports connected in parallel, each corresponding to one of the connection openings formed on the housing; at least one foolproof seal device for covering the connection openings in such a manner that only one of the connection openings is exposed to outside at a time; and at least one switch device for ensuring that the output terminal of the voltage-converting circuit outputs a voltage corresponding to the connection opening exposed to outside.

### FIELD OF THE INVENTION

The present invention relates to a power supply and, more particularly, to a multi-output power source with a foolproof seal device.

### BACKGROUND OF THE INVENTION

To increase the application convenience, electronic appliances have been made smaller and smaller. However, the power supplies working with the electronic appliances have various specifications. As a result, the common consumers usually have various types of power supplies at home, which vary in both output voltage and adapter dimensions. Consequently, these power suppliers cannot be interchangeably used among different electronic appliances. Thus, the power supplies used in some industries, such as in the laptop computer industry, were gradually unified into one or two common types of voltage specification, such as 19V or 16V. A more common example is the standardized USB connector, which universally supplies 5V DC power. As regards the tablet PCs, they usually receive 12V DC power from their power supplies.

Besides the conventional power supplies used for converting the 110V or 220V AC mains power to DC power, portable chargers are prevalent just now. A user could store power in a portable charger in advance and, after his/her mobile phone or tablet PC runs out of power, couple the mobile phone or tablet PC to the portable charge to receive power. For the purpose of illustration, the power supply and portable charge are generally referred to herein as a power source.

A data processing product, such as a computer, and a communication product, such as a mobile phone, differ from each other in terms of function and size and are normally designed to take power from different types of power sources. In this information era, consumers of electronic products and millions of 3C users often carry both types of portable products at the same time and, therefore, would require a power source applicable to these two types of consumer electronics. As a consequence, a common power source that has a 19V adapter and a 5V USB adapter is produced, which is also equipped with two transformation circuits to output the two different voltages.

For these consumers, a power source that can supply power to both data processing products and communication products is apparently the first choice, which is also expected to be affordable and highly portable. To supply power to different products, the conventional power source is built in with multiple circuits to provide different voltages and thus requires a large circuit board to layout the circuits. Consequently, the conventional power source is very burdensome for a consumer due to its heavy weight and poor usage and fails to meet the trend of minimization of consumer electronics. As the circuit components constitute the major cost of a power source, the current trend of laying out as many circuits as possible in a power source would inevitably lead to an increase in the manufacture cost, causing the conventional power source unable to meet the consumer's consistent demand for lower price.

To sum up, the conventional power sources available in the market are not user-friendly due to their heavy weight, large size and high price. The invention is to provide a smaller-sized, cost-effective multi-output power source for supplying different voltages. It allows consumers to have access to a portable and smaller multi-output power source at an affordable price.

### SUMMARY OF INVENTION

The first aspect of the invention is to provide a light-weight and portable multi-output power source with a foolproof seal device.

The second aspect of the invention is to provide a multi-output power source integrated with a foolproof design.

The third aspect of the invention is to provide a more convenient multi-output power source with foolproof seal device.

The fourth aspect of the invention is to provide a multi-output power source which includes less circuit components to reduce manufacture cost.

Therefore, the present invention provides a multi-output power source provided with a foolproof seal device, comprising a housing formed with a plurality of exposed connection openings; an voltage-converting circuit having an output terminal; a plurality of output ports connected in parallel, each corresponding to one of the connection openings formed on the housing; at least one foolproof seal device for covering the connection openings in such a manner that only one of the connection openings is exposed to outside at a time; and at least one switch device for ensuring that the output terminal of the voltage-converting circuit outputs a voltage corresponding to the connection opening exposed to outside.

The multi-output power source disclosed herein can output different voltages through a single voltage-converting circuit. Compared with the conventional power source where multiple voltage-converting circuits are used to provide different voltages at the same time, the invention outputs one of various voltages at a time by means of a switch device to reduce the manufacture cost for building up the voltage-converting circuit and the circuit components, thereby providing the consumers with a light-weight and affordable multi-output power source to meet the trend that one person owns various 3C products (which may include a laptop computer, a mobile phone, a CD player and so on). In addition, the invention is provided with the foolproof seal device for the switching operation, allowing the user to switch the voltage by itself to ensure that the user accurately understands the actual level of the output voltage. By doing so, the invention reduces the risk of misuse by the user.

### BRIEF DESCRIPTION OF THE DRAWINGS

FIG. 1 is a schematic perspective view of the first preferred embodiment of the invention;

FIG. 2 is an enlarged diagram showing a partial structure of the first preferred embodiment;

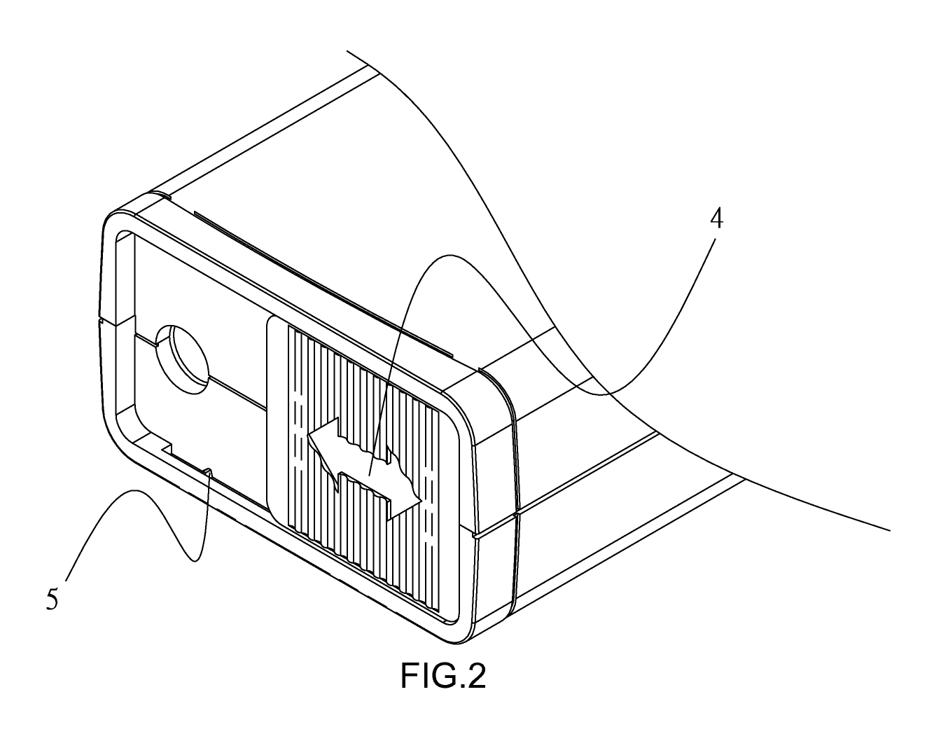

FIG. 3 is a simplified circuit diagram of the first preferred embodiment of the invention;

FIG. 4 is another simplified circuit diagram of the first preferred embodiment of the invention;

FIG. 5 is an enlarged diagram showing a partial structure of the second preferred embodiment; and

FIG. 6 is a side view of the third preferred embodiment of the invention.

### DETAIL DESCRIPTIONS OF THE PREFERRED EMBODIMENTS

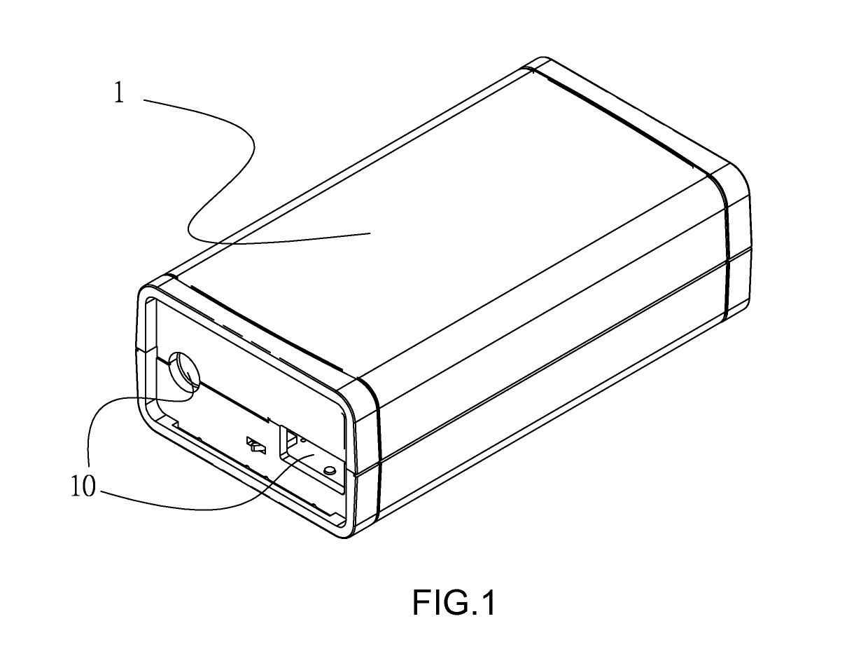

In the information era, most young people have more than one kind of electronics, such as a laptop computer, a mobile phone and a tablet PC. The increasing number of 3C users covers all generations. Hence, consumer electronics have gradually become a life necessity. To meet the consumers' demand for portable electronics with a long lifespan, the invention proposed a cost-effective and light-weight multi-output power source integrated with a foolproof design. As shown in FIGS. 1˜4, a multi-output power source with a foolproof seal device according to the first preferred embodiment of the invention comprises a housing 1, on which a plurality of connection openings 10 are formed (two connection openings were illustrated in this embodiment). The housing 1 accommodates a voltage-converting circuit 2, which is terminated with an output terminal 20. The output terminal 20 is connected to a plurality of output ports 3, such as two output ports as illustrated in this embodiment. The outputs port 3 are used to connect an external electronic product to the voltage-converting circuit 2, and each of the output ports 3 corresponds to one of the connection openings 10 formed on the housing 1. As regards the foolproof design, the invention uses a switch device 5, such as a micro switch 5, to change voltages from one to another and/or move the foolproof seal device 4 from one position to another. While one of the two connection openings 10 is opened to the outside, the foolproof seal device 4 will cover the other connection opening 10, achieving the foolproof effect. It should be noted that the switch device 5 may comprise one or more micro switches.

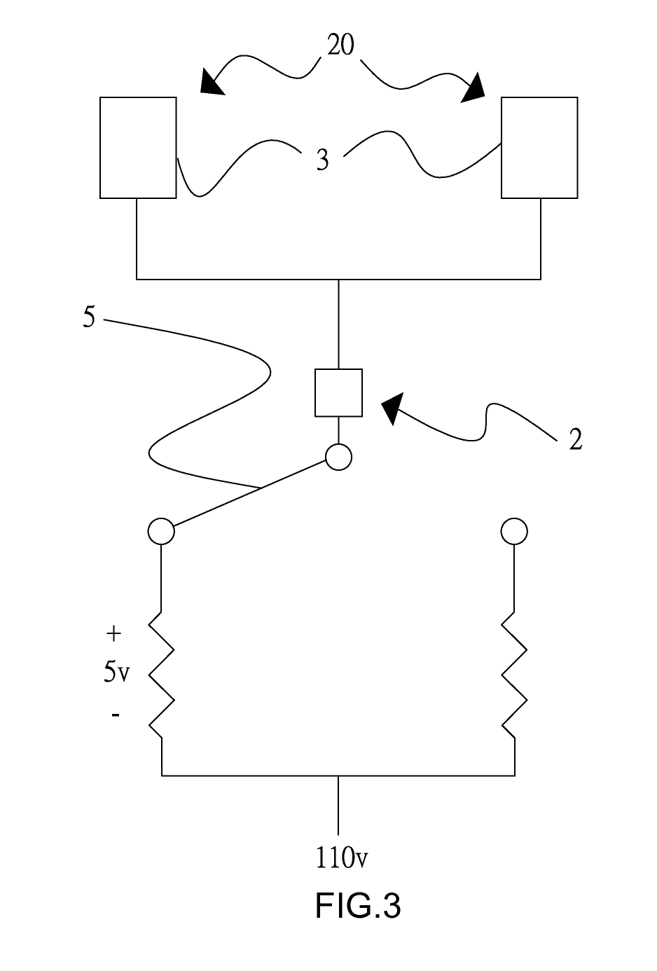

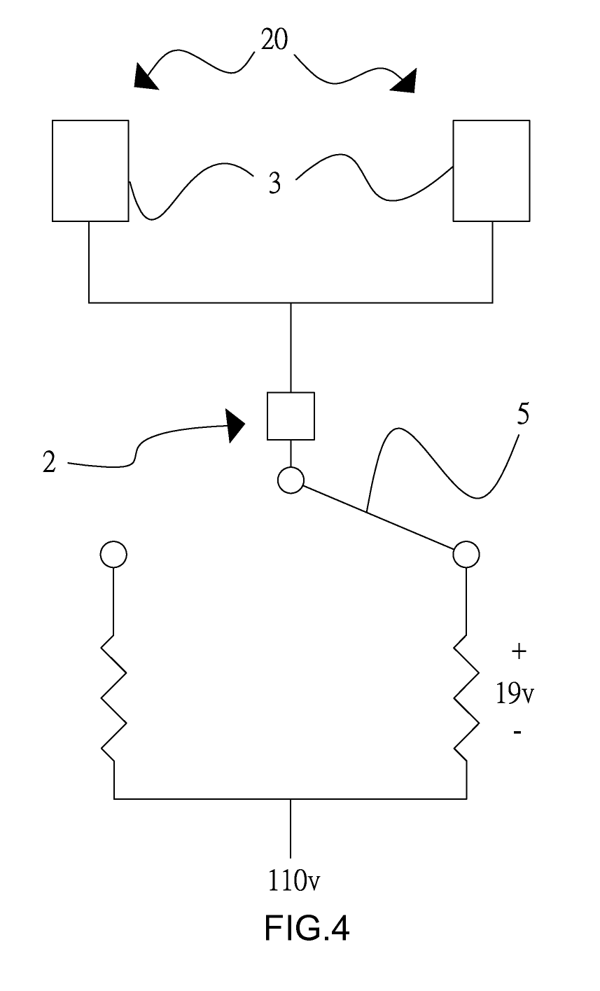

FIGS. 3 and 4 are simplified circuit diagrams that demonstrate the technical concept of the invention. As shown, the 110V AC power will pass through one of the two circuits to reach the output terminal 20, and the circuit is mounted with a resistor or has a proper winding turns ratio to convert the AC voltage of 110V to an desired voltage level. In this embodiment, the voltage is converted to 5V in one circuit, and to 19V in the other circuit. When the invention is going to supply power to a 5V CD player, the user can turn the switch device 5 to connect with the 5V circuit, while the other circuit for supplying 19V becomes open. A rectifier is provided in the voltage-converting circuit 2 to convert the AC power into DC power. As a result, the two output ports 3 output a DC voltage of 5V. Meanwhile, the foolproof seal device 4 covers the output port 3 for outputting 19V and only the output port 3 of 5V is exposed, so as to reduce the possibility of supplying an incorrect voltage to the electronic product coupled to the output port 3. The conversion of 110V to a DC voltage of 19V is the similar to that for 5V, and the only difference is the positions of the foolproof seal device 4 and the switch device 5. This embodiment employs the minimum circuit components and circuit layout to provide different voltages, thereby lowering the manufacture cost and reducing the size of the power source. It provides the consumers with a slim, affordable multi-output product.

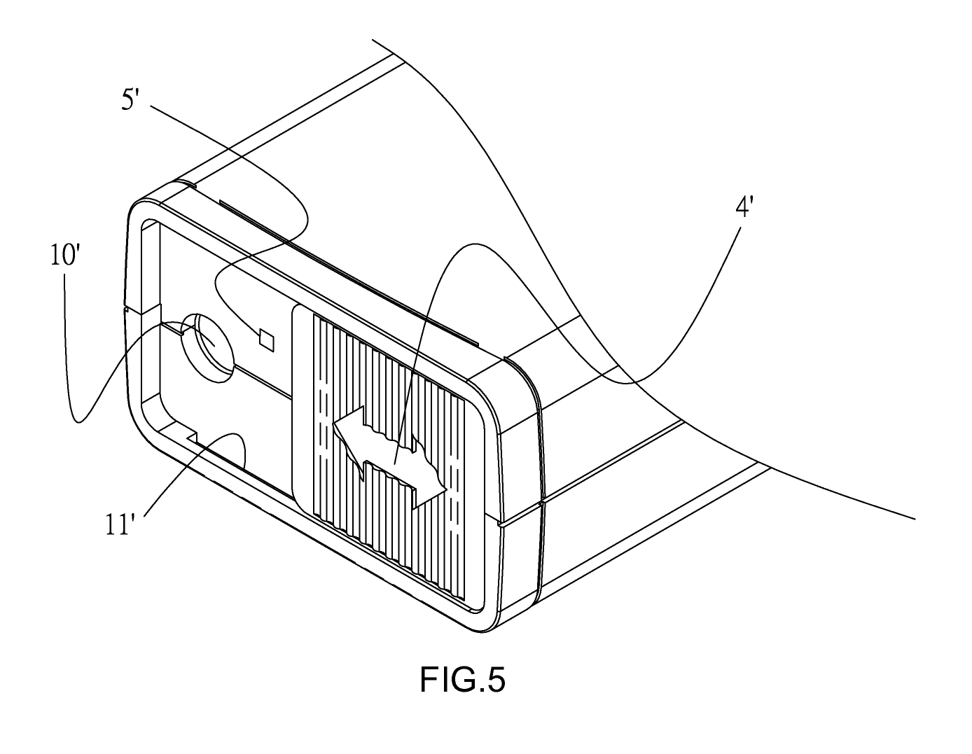

FIG. 5 shows a second preferred embodiment of the invention, in which the switch device is a magnetron switch 5′ and the foolproof seal device is a sliding shield member 4′ equipped with a magnetic element corresponding to the magnetron switch 5′ (not shown). The sliding shield member 4′ is adapted to slide between two connection openings 10′ along a guiding groove 11′. In this embodiment, the respective two connection openings 10′ correspond to the respective two output ports and the magnetron switch 5′ is mounted near one of the connection openings 10′. When the user switches the output port from one to the other by moving the sliding shield member 4′, the sliding shield member 4′ will magnetically interact with the magnetron switch 5′ near the connection opening 10′. By virtue of the magnetic interaction, the magnetron switch 5′ switches the circuit from one to the other to change the level of the output voltage. In this embodiment, the user only need to control the sliding shield member 4′ to open up a certain connection opening 10′ for outputting a certain voltage, and the voltage conversion will be activated automatically.

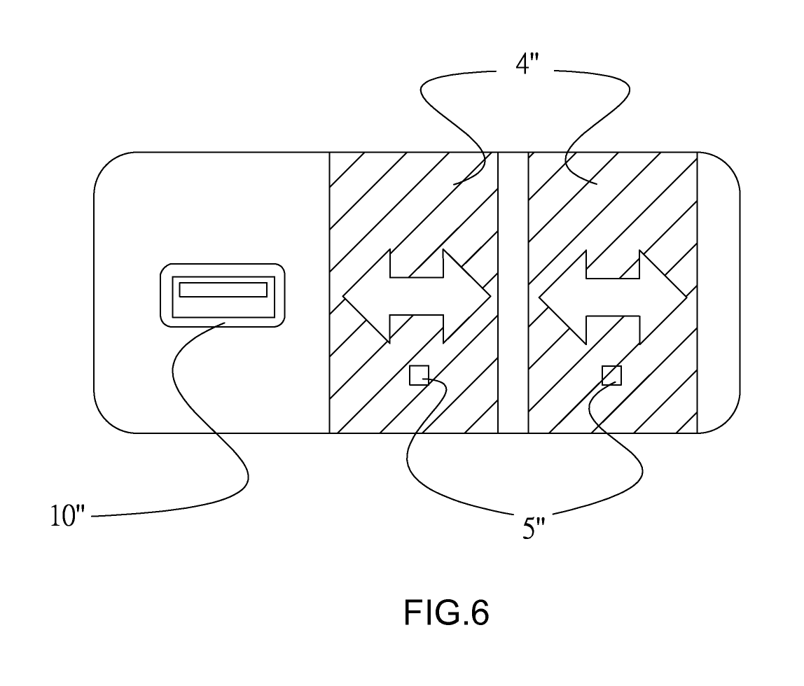

It is apparent to those skilled in the art that the power source disclosed herein can be provided with more than two output ports, and provided with more than one foolproof seal device to manage the circuits. According to the third embodiment of the invention shown in FIG. 6, three connection openings 10″ are formed, each corresponding to an output port, and two foolproof seal devices 4″ are provided. In this embodiment, two micro switches 5″ are mounted near two of the three connection openings 10″, respectively, and the remaining one of the connection openings 10″ is not provided with any micro switch. When only one of the two micro switches 5″ is pressed by the foolproof seal device 4″, the voltage corresponding to the connection opening 10″ that is not pressed is chosen by the user to output from the power source. If two connection openings 10″ are pressed by the foolproof seal device 4″ simultaneously, the voltage corresponding to the third connection opening 10″ which is not equipped with micro switch 5″ is chosen to output. The output ports described herein may be configured as one or more universal serial buses.

Since the output ports of the invented power source are connected in parallel, the overall circuit layout is simplified and the number of circuit components used is reduced, whereby the manufacture cost of the invented power source is lowered and the size of the invented power source is reduced. By doing so, it achieves the purpose of being light and slim and meets the market demands of lower price. When the user chooses a certain output voltage, the respective output ports are made to provide the same output voltage simultaneously. For example, when the user chooses 19V, even the USB output port can only output 19V, and this does not comply with the usage habit of the consumers. Therefore, the invention takes advantage of the foolproof device to effectively close up the output ports that are not desired. In this way, the invention eliminates the possibility of damaging electronic products due to the special design of the invention. The invention is particularly useful when the user carries the invented power source with him and charges his electronic products in turns rather than at the same time. The invention compromises of charging different voltages to several electronic products at the same time, thereby providing a light-weight and affordable multi-output power source which only outputs one of various voltages at a time.

The three preferred embodiments above are only described for illustration purpose. For example, the input voltage of 110V/220V and the output voltage of 5V/19V mentioned above are only described for illustration and should not be interpreted as limitation to the scope of the invention. It should be recognized that various modifications and changes, which will be apparent to those skilled in the relevant art, may be made without departing from the spirit of the invention and the scope thereof as defined in the appended claims.

What is claimed is:

1. A multi-output power source with a foolproof seal device comprising:
a housing formed with a plurality of exposed connection openings;
an voltage-converting circuit having an output terminal;
a plurality of output ports connected in parallel, each corresponding to one of the connection openings formed on the housing;
at least one foolproof seal device for covering the connection openings in such a manner that only one of the connection openings is exposed to outside at a time; and
at least one switch device for ensuring that the output terminal of the voltage-converting circuit outputs a voltage corresponding to the connection opening exposed to outside.

2. The multi-output power source with a foolproof seal device according to claim 1, wherein the output ports comprise a universal serial bus.

3. The multi-output power source with a foolproof seal device according to claim 1, wherein the switch device comprises a micro switch mounted near one of the connection openings.

4. The multi-output power source with a foolproof seal device according to claim 1, wherein the foolproof seal device comprises a sliding shield member.

5. The multi-output power source with a foolproof seal device according to claim 4, wherein the housing is formed with a guiding groove, along which the sliding shield member can slide to have the connection openings open or closed.

6. The multi-output power source with a foolproof seal device according to claim 1, comprising two output ports connected in parallel and a foolproof seal device.

7. The multi-output power source with a foolproof seal device according to claim 1, comprising three output ports connected in parallel and two foolproof seal devices.
